(19) United States
(12) Patent Application Publication
(10) Pub. No.: US 2015/0199660 A1
(43) Pub. Date: Jul. 16, 2015

(54) COMMUNICATION NETWORK FOR COLLECTING DATA AND EXECUTING ELECTRONIC TRANSACTION SERVICES

(71) Applicant: Bank of America Corporation, Charlotte, NC (US)

(72) Inventors: Bonnie L. Dolan, Lincoln, CA (US); Shilpoo Agrawal, Charlotte, NC (US); Joseph B. Castinado, Northglenn, CO (US); Jack L. Vaalburg, Boothwyn, PA (US)

(73) Assignee: Bank of America Corporation, Charlotte, NC (US)

(21) Appl. No.: 14/154,764

(22) Filed: Jan. 14, 2014

(51) Int. Cl. G06Q 20/10; G06Q 20/38; G06Q 20/40

(52) U.S. Cl. CPC G06Q 20/10; G06Q 20/40; G06Q 20/381

(57) ABSTRACT

A system for executing electronic fund transfers includes a memory comprising a database, the database configured to store electronic fund transfer data, a first interface communicatively coupled to the memory and configured to receive electronic fund transfer customer data associated with a customer and requested electronic fund transfer data describing a requested electronic fund transfer requested by the customer, and one or more processors communicatively coupled to the first interface and configured to determine, based on the received customer data, stored electronic fund transfer data associated with the received customer data and populate fields of the first interface with the stored electronic fund transfer data associated with the received customer data.

### TECHNICAL FIELD

This disclosure relates generally to a communication network for collecting data and executing electronic transaction services.

### BACKGROUND

Enterprises may offer a number of electronic transaction services to customers, such as individuals, businesses, organizations, or other entities. Often, electronic transaction services require an enterprise to obtain large amounts of data from customers and manually enter it into electronic transaction service systems in order to execute a requested electronic transaction service. Customers may repeatedly request similar electronic transaction services from the same or different enterprise locations. Manually entering customer data to execute electronic transaction services can be time consuming and slow the process of executing electronic transaction services.

Electronic transaction services are often subject to regulations, for example, from governments, agencies, trade groups, or other organization. Often, electronic transaction services involve generating a number of documents and/or receiving customer confirmations (e.g., customer signatures), for example, because they are required by particular regulations. Generating and printing documents can be time consuming and slow the process of executing electronic transaction services.

Occasionally, customers may not satisfy particular criteria for an electronic transaction service and an enterprise employee assisting the customer may have to obtain authorization from an enterprise administrator to execute the requested electronic transaction service. Enterprise administrators may be difficult to reach and the administrator approval process can also be time consuming and slow the process of executing electronic transaction services.

### SUMMARY OF EXAMPLE EMBODIMENTS

According to embodiments of the present disclosure, disadvantages and problems associated with collecting data and executing electronic transaction services may be reduced or eliminated.

In certain embodiments, a system for executing electronic fund transfers includes a memory comprising a database, the database configured to store electronic fund transfer data, a first interface communicatively coupled to the memory and configured to receive electronic fund transfer customer data associated with a customer and requested electronic fund transfer data describing a requested electronic fund transfer requested by the customer, and one or more processors communicatively coupled to the first interface and configured to determine, based on the received customer data, stored electronic fund transfer data associated with the received customer data and populate fields of the first interface with the stored electronic fund transfer data associated with the received customer data.

Certain embodiments of the present disclosure may provide one or more technical advantages having specific technical effects.

In certain embodiments, a system for executing electronic fund transfers automatically populates data necessary to execute an electronic fund transfer from a database to an interface of a computing platform to reduce the amount of time a user must occupy the computing platform to execute the electronic fund transfer, thereby conserving the computational resources necessary to perform the electronic fund transfer that would be consumed by manually entering the necessary data.

In certain embodiments, a system for executing electronic fund transfers automatically generates documents with necessary fields completed, displays the generated documents, and/or receives customer confirmations (e.g., signatures) necessary to execute an electronic fund transfer to reduce the amount of time a user must occupy the computing platform to execute the electronic fund transfer, thereby conserving the computational resources necessary to perform the electronic fund transfer that would be consumed by manually completing the fields of the documents.

In certain embodiments, a system for executing electronic fund transfers electronically alerts administrators when an electronic fund transfer requires administrator review, electronically provides the administrator access to necessary data associated with the electronic fund transfer, and allows the administrator to electronically communicate authorization of the electronic fund transfer to reduce the time necessary to execute the electronic fund transfer, thereby conserving the computational resources necessary to perform the electronic fund transfer that would be consumed obtaining administrator review using less efficient contact methods.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example system for collecting data and executing electronic transaction services;

FIG. 2 illustrates an example interface of a system for collecting data and executing electronic transaction services;

FIG. 3 illustrates an example interface of a system for collecting data and executing electronic transaction services; and

FIG. 4 illustrates a flow chart of an example method for collecting data and executing electronic transaction services.

### DETAILED DESCRIPTION

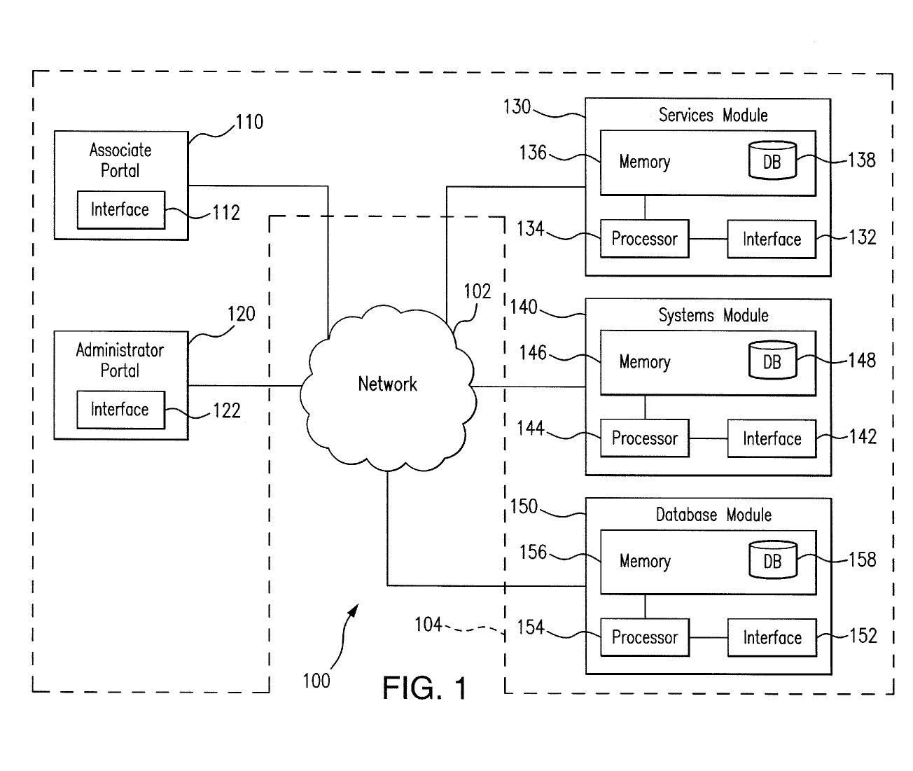

Embodiments of the present disclosure and its advantages are best understood by referring to FIGS. 1 through 4 of the drawings, like numerals being used for like and corresponding parts of the various drawings.

In certain embodiments, an enterprise (e.g., a financial institution) includes a system for executing electronic transaction services that supports electronic fund transfers. Enterprise employees (e.g., associates) may assist electronic fund transfer customers in executing an electronic fund transfer, for example, at a branch location of the enterprise. In an embodiment, an enterprise associate obtains customer information from the electronic fund transfer customer and inputs the customer data into an associate portal. For example, a customer may provide their name, account information, phone number, swipe a bank card, or provide any other suitable identifying information. In an embodiment, the system searches for stored data associated with the customer (e.g., customer account data, data associated with electronic fund transfers previously executed for the customer, or other suitable information). If stored information is found that is associated with the customer, the associate portal may automatically populate the stored information into data fields required to execute the requested electronic fund transfer, thereby avoiding time consuming manual data entry that ties up computing resources and bandwidth.

In an embodiment, the customer provides details about a requested electronic fund transfer, including one or more of a source account, a destination account, a destination financial institution, and an amount of money to transfer. The associate portal may allow the enterprise associate to search previous electronic fund transfers executed for the customer. If the customer has made an identical or similar electronic fund transfer, the associate portal may populate fields of the associate portal with relevant data, thereby avoiding time consuming manual data entry. In an embodiment, if there are any remaining unpopulated fields, the enterprise associate may manually enter the relevant data.

The associate portal may prompt the enterprise associate to obtain particular information from the customer or to provide particular disclosures and/or documents to the customer. For example, the associate portal may identify required forms of identification to execute a requested electronic fund transfer, notify the associate to provide disclosures and/or documents about the requested electronic fund transfer, notify the associate to obtain authorization from the customer to execute the requested electronic fund transfer, notify the associate that the requested electronic fund transfer requires administrator approval, or any other suitable message associated with executing electronic fund transfers.

Particular electronic fund transfers may require administrator approval, for example, because the transfer will result in a negative balance, the transfer exceeds a predetermined amount allowed for the associate, the customer lacks certain identification documents, or any other suitable reason. In an embodiment, the associate portal is operable to communicate authorization request messages to an administrator portal. The administrator portal may alert an administrator that an authorization request is pending, provide the administrator access to data associated with the customer and/or the requested electronic fund transfer, and provide the administrator with the option to authorize the electronic fund transfer, authorize the electronic fund transfer if the customer complies with particular conditions, or to deny the electronic fund transfer. In certain embodiments, the administrator portal communicates the administrator decision to the associate portal.

If the electronic fund transfer is authorized, the associate portal may be operable to execute the electronic fund transfer. In certain embodiments, the associate portal is operable to initiate an electronic fund transfer, put a hold on an electronic fund transfer (e.g., prevent the electronic fund transfer from executing), edit a pending electronic fund transfer, and/or cancel a pending electronic fund transfer. Once an electronic fund transfer has executed, the system may store data associated with the electronic fund transfer (e.g., to use for future electronic fund transfers).

FIG. 1 illustrates an example system 100 for collecting data and executing electronic transaction services. Electronic transaction services include services provided by enterprises 104 associated with electronic transactions, for example, executing electronic transaction services (e.g., electronic fund transfers), identifying potential transactions for customers (e.g., fund transfers with lower costs or fund transfers to accounts with higher interest yields), providing advantages of proposed fund transfers, providing access to a plurality of accounts from one or more sources of record (e.g., an entity maintaining an account) through a single application and/or interface (e.g., a user facing application), proposing accounts to involve in a transaction, adding or removing limitations to transaction services for particular users and/or accounts, limiting the types of accounts involved in particular transactions, and identifying beneficial routes for fund transfers (e.g., low cost, high reliability, and/or fast processing time). The present disclosure often references a particular electronic transaction as an example, and electronic fund transfer (e.g., wire and ACH transfer of funds), however, it is understood that the present disclosure applies to any suitable electronic transaction service. According to an embodiment, system 100 includes network 102 and enterprise 104. Enterprise 104 may include associate portal 110, administrator portal 120, services module 130, systems module 140, and database module 150. In certain embodiments, enterprise 104 includes associate portal 110, administrator portal 120, services module 130, systems module 140, and database module 150.

Network 102 represents any suitable network operable to facilitate communication between components of system 100, such as enterprise 104, associate portal 110, administrator portal 120, services module 130, systems module 140, and database module 150. Network 102 may include any interconnecting system capable of transmitting audio, video, electrical signals, optical signals, data, messages, or any combination of the preceding. Network 102 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

Enterprise 104 represents an entity that maintains and/or operates associate portal 110, administrator portal 120, services module 130, systems module 140, and database module 150. Enterprise 104 may be any suitable type of business entity. In certain embodiments, enterprise 104 has different business units or subdivisions that handle different business activities. Different subdivisions of enterprise 104 may maintain and/or operate one or more of associate portal 110, administrator portal 120, services module 130, systems module 140, and database module 150. In particular embodiments, enterprises 104 may include organizations such as commercial banks, savings and loan associations, credit unions, Internet banks, mutual fund companies, brokerage firms, credit card companies, or other providers of electronic transaction services.

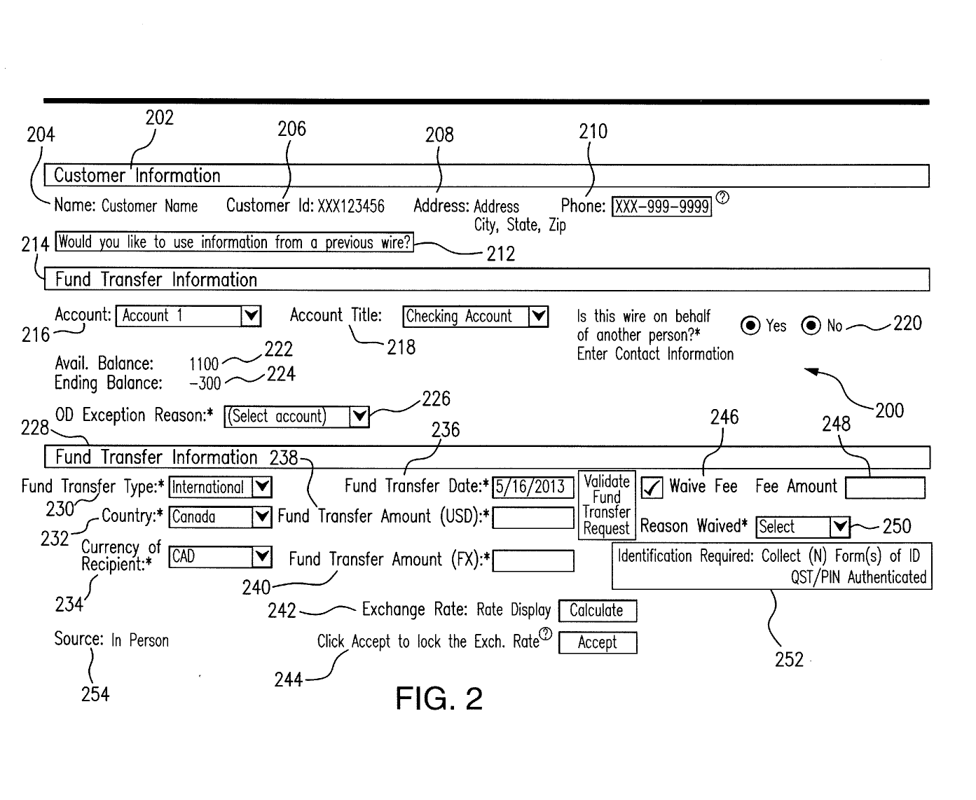

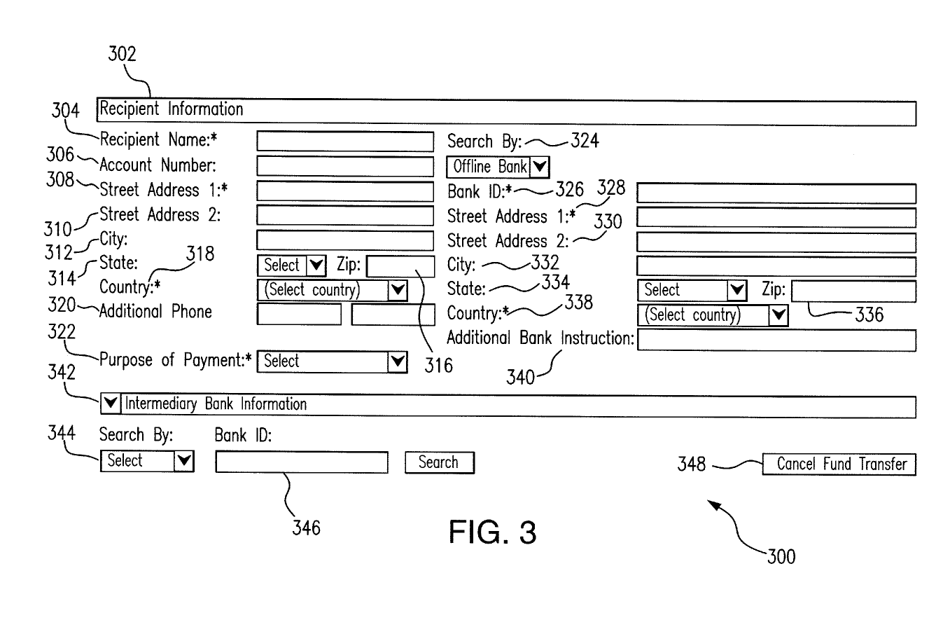

Associate portal 110 represents a web portal to one or more enterprise 104 services, for example, provided by services module 130. In certain embodiments, associate portal 110 is accessible by enterprise 104 employees (e.g., enterprise 104 associates) to provide customers of enterprise 104 electronic transaction services (e.g., electronic fund transfers). Some or all functions provided through associate portal 110 may also be provided to enterprise 104 customers (e.g., through a customer facing website). In particular embodiments, associate portal 110 includes an interface 112 (e.g., a graphical user interface (GUI)). An example of interface 112 is discussed below with respect to FIGS. 2 and 3.

In certain embodiments, associate portal 110 is operable to receive and/or display information related to providing electronic transaction services to enterprise 104 customers. System 100 may be operable to automatically populate and display information through associate portal 110 based on received information and archived information. For example, an enterprise 104 associate may input enterprise 104 customer identification information, such as an account number (e.g., from a customer swiping an account card), and system 100 may automatically populate and display other information related to the particular customer, for example, other accounts, account balances, customer address information, previous electronic transaction services executed for the customer, or any other information related to the customer. In certain embodiments, fields of associate portal 110 can be edited (e.g., after data is populated).

In particular embodiments, associate portal 110 is operable to receive and/or display customer information, customer account information, previous electronic transaction services executed for the customer (e.g., electronic fund transfers), information relating to entities associated with the customer (e.g., destination accounts of electronic fund transfers previously executed by the customer), or any other suitable information. Associate portal 110 may also be operable to generate documents and receive customer authorization to execute electronic transaction services. For example, associate portal 110 may generate documents based on the information input or populated into associated portal 110.

In certain embodiments, particular electronic transaction services are regulated (e.g., by organizations, agencies, governments, or other regulatory body). Regulations may contain certain requirements for particular electronic transaction service (e.g., disclosures, customer confirmation, customer authorization, documents, etc.). For example, enterprises 104 providing international electronic fund transfers may be required to provide customers with a prepayment disclosure document that includes the costs associated with a particular electronic fund transfer before executing an electronic fund transfer (e.g., is generated and/or presented to the customer before execution of an electronic fund transfer), a receipt that includes the costs incurred by the electronic fund transfer after executing an electronic fund transfer (e.g., is generated and/or presented to the customer after an electronic fund transfer is initiated), a fund transfer request authorization that is executed by the customer to authorize the electronic fund transfer, or other disclosure or document. Additionally, enterprises 104 may have internal requirements for particular electronic transaction services.

In particular embodiments, associate portal 110 is operable to prompt enterprise 104 associates to comply with requirements (e.g., internal, regulatory, or other) associated with a particular electronic transaction services, such as providing particular disclosures or documents. In an embodiment, associate portal 110 is operable to receive confirmation from enterprise 104 associates or customers that particular requirements have been complied with, for example, through check boxes and/or electronic signatures. Associate portal 110 may, based on information input or populated into associate portal 110, access a database (e.g., database module 150) of rules applicable to a particular electronic transaction service and prompt enterprise 104 associates to comply with particular requirements (e.g., provide disclosures, generate documents, obtain customer signatures, or other requirement).

Certain electronic transaction services may require approval from an enterprise 104 administrator (e.g., an enterprise 104 employee with authority to authorize and/or deny electronic transaction services). For example, electronic fund transfers that result in a negative balance or electronic fund transfers exceeding an allowed amount for an enterprise 104 associate may require approval of an administrator. Associate portal 110 may, based on information entered or populated into associate portal 110, prompt enterprise 104 associates when an electronic transaction service requires approval of an administrator. In certain embodiments, associate portal 110 is operable to generate an authorization request message that includes details of the proposed electronic service transaction and communicate the message to one or more administrators (e.g., through e-mail or other message). Administrators may receive authorization request messages at administrator portal 120. In an embodiment, an administrator may deny an electronic transaction service, approve an electronic transaction service, or approve an electronic service request with additional conditions that must be satisfied (e.g., show additional forms of identification, qualify for a line of credit, have a minimum amount of funds, or other condition).

Administrator portal 120 represents a web portal for enterprise 104 administrators to one or more enterprise 104 services, for example, provided by services module 130. Enterprise 104 administrators represent personnel within enterprise 104 with the authority to determine whether to execute an electronic transaction service on behalf of a customer (e.g., an electronic fund transfer). In certain embodiments, administrator portal 120 is operable to receive authorization request messages from associate portal 110, provide access to details of a particular electronic transaction service, provide access to one or more accounts associated with an electronic transaction service, search an archive of customers and/or electronic transaction services for particular customer and/or electronic transaction service data, cancel particular electronic transaction services, confirm particular electronic transaction services (e.g., confirm customer authorization), authorize particular electronic transaction services, deny particular electronic transaction services, apply transaction requirements to electronic transaction services (e.g., accessing an electronic transaction service rules database), or any other suitable function associated with overseeing electronic transaction services.

Services module 130 represents a component of system 100 that provides services to components of system 100 (e.g., associate portal 110 and administrator portal 120). In an embodiment, services module 130 includes interface 132, processor 134, memory 136, and database 138. Services module 130 may utilize other components of system 100 in providing services to components of system 100. For example, services module 130 may communicate with systems module 140 and/or database module 150 to provide services to associate portal 110 and/or administrator portal 120. In an embodiment, services module 130 provides an intermediate interface (e.g., a web service interface) between associate module 110 and/or administrator module 120 and systems module 140 and/or database module 150.

In certain embodiments, services module 130 is operable to access market exchange rates of various monetary currencies. Services module 130 may further be operable to communicate with foreign exchange markets to lock in particular exchange rates (e.g., to guarantee the rate for a period of time). In certain embodiments, services module 130 is operable to execute electronic transaction services such as electronic fund transfers (e.g., electronic fund transfer) for system 100. Services module 130 may be operable to initiate, cancel (e.g., within a determined period of time after initiating the transfer) or hold (e.g., for a determined period of time) electronic fund transfers. In certain embodiments, services module 130 is operable to edit pending electronic fund transfers. Services module 130 may be operable to receive confirmation that a customer requesting an electronic fund transfer has received disclosure documents and/or authorized execution of a requested electronic fund transfer.

In particular embodiments, services module 130 is operable to obtain information related to financial institutions (e.g., banks) that participate in electronic fund transfers. For example, services module 130 may be operable to obtain routing numbers associated with financial institutions and associate the routing numbers with the corresponding financial institutions. In particular embodiments, services module 130 is operable to obtain contact information for financial institutions. Services module 130 may be operable to determine costs (e.g., fees and/or taxes) associated with particular services provided by financial institutions. In an embodiment, services module 130 is operable to determine reliability metrics associated with particular financial institutions for services provided by the financial institution (e.g., time to complete services, reliability of cost information associated with the financial institution, or other reliability metric). Services module 130 may be operable to determine electronic fund transfer regulations applicable to particular countries and currencies (e.g., available days for electronic fund transfers). Services module 130 may be able to search a database (e.g., database module 150) to identify particular financial institutions based on criteria such as address, routing number, country, services provided by the financial institution, costs and taxes associated with services provided by the financial institution, or other suitable criteria. In an embodiment, services module 130 is operable to store data associated with electronic fund transfers and/or customers in a database (e.g., database module 150). Services module 130 may be operable to store and/or index documents presented to and/or executed by customers requesting electronic fund transfers.

Associate portal 110 and/or administrator portal 120 may be operable to access any one or more services provided by services module 130 and may be operable to display any data provided by services module 130. For example, associate portal 110 and/or administrator portal 120 may be able to populate data fields of interfaces 112 and/or 122 with data provided by services module 130.

Systems module 140 represents a component of system 100 that provides support functionality to components of system 100 (e.g., services module 130). Systems module 140 may include backend systems that support services module 130. In an embodiment, systems module 140 includes interface 142, processor 144, memory 146, and database 148. Systems module 140 may include an account system operable to access financial accounts associated with customers requesting electronic transaction services (e.g., electronic fund transfers). In certain embodiments, the account system provides account data, account balances, alerts associated with accounts (e.g., customer travel alerts). Systems module 140 may include a foreign exchange rate system operable to access foreign exchange rate markets. In an embodiment, the foreign exchange rate system is operable to lock in an exchange rate (e.g., guarantee the exchange rate for a particular period of time). Systems module 140 may include a document generation system operable to generate documents used in electronic transaction services (e.g., electronic fund transfers).

In certain embodiments, the document generation system is operable to generate documents based on data collected at associate portal 110, administrator portal 120, or from records stored in database module 150. Generated documents may include prepayment disclosures that describe the costs a customer will incur for a particular electronic transaction service (e.g., electronic fund transfer), a receipt (e.g., a remittance transfer receipt) that describes the costs the customer incurred for an electronic transaction service (e.g., electronic fund transfer), funds transfer request authorization documents that memorialize a customer's authorization to execute an electronic transaction service (e.g., electronic fund transfer), or any other suitable disclosure or document.

In particular embodiments, systems module 140 includes a document storage system operable to store, retrieve, and/or index (e.g., categorize) documents associated with electronic transaction services (e.g., prepayment disclosure documents, service receipts, funds transfer request authorization documents, or other document). The document storage system may be operable to index documents according to particular criteria, and then search indexed documents according to the index criteria. In an embodiment, systems module 140 includes a fund transfer system (e.g., a wire and /or ACH transfer engine) operable to execute electronic fund transfers. The fund transfer system may be operable to execute account debits, account credits, and messages (e.g., inter- or intra-bank messages) associated with electronic fund transfers.

In certain embodiments, systems module 140 includes a pricing system operable to determine and/or calculate costs (e.g., fees and taxes) associated with electronic transaction services (e.g., electronic fund transfers). The pricing system may further be operable to determine the days available for electronic transaction services (e.g. electronic fund transfers) for various financial institutions, currencies, and/or countries. In particular embodiments, systems module 140 includes a financial institution information system operable to access, maintain, and/or store data associated with financial institutions. For example, the financial institution information system may access, maintain, and/or store routing information (e.g., routing numbers) for various financial institutions. In an embodiment, systems module 140 includes a currency information system that is operable to access currency and/or country regulations and/or rules applicable to electronic transactions services (e.g., electronic fund transfers).

Database module 150 represents a component of system 100 operable to store information associated with electronic transaction services. Database module 150 may store historical electronic transaction service data, enterprise customer data, electronic transaction service requirements, relationships of financial institutions to routing numbers, electronic fund transfer routing information, documents associated with executed electronic transaction services (e.g., disclosure documents, authorization documents, etc.), electronic transaction pricing information (e.g., fees, taxes, and/or other costs), business days for financial institutions in various countries (e.g., fund transfer availability days), country and/or currency rules associated with electronic transactions services (e.g., international electronic fund transfers).

A module (e.g., modules 130, 140, and 150) may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of a module may be performed by any suitable combination of one or more servers or other components at one or more locations. In embodiments where modules represent a server, the server may be a private server, and the server may be a virtual or physical server. Additionally, a module may include any suitable component that functions as a server.

Components of system 100, such as services module 130, systems module 140, and database module 150, may include one or more processors. A processor represents any computing device, such as processors 134, 144, and 154, configured to control the operation of one or more components of system 100. A processor may comprise one or more processors and may be a programmable logic device, a microcontroller, a microprocessor, any suitable processing device, or any suitable combination of the preceding. A processor includes any hardware that operates to control and process information received by a component of system 100. In certain embodiments, a processor communicatively couples to other components of system 100, such as a module (e.g., modules 130, 140, and 150), an interface (e.g., interfaces 112, 122, 132, 142, and 152), a memory (e.g., memories 136, 146, and 156), a database (e.g., databases 138, 148, and 158), or any other suitable component.

An interface represents any device, such as interfaces 112, 122, 132, 142, and 152 operable to receive input, send output, process the input or output, or perform other suitable operations for a component of system 100. An interface includes any port or connection, real or virtual, including any suitable hardware or software, including protocol conversion and data processing capabilities, to communicate through network 102. In certain embodiments, an interface includes a user interface (e.g., physical input, graphical user interface, touchscreen, buttons, switches, transducer, or any other suitable method to receive input from a user).

A memory represents any device, such as memories 136, 146, and 156 operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 138, 148, and 158).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

Modifications, additions, or omissions may be made to system 100. System 100 may include more, fewer, or other components. Any suitable component of system 100 may include a processor, interface, logic, memory, or other suitable element. Any suitable fields of portals 110 and 120 may be edited. System 100 may be operable to analyze account data for a customer to determine whether an electronic fund transfer should be authorized. For example, a customer may have sufficient funds in a source account to initiate an electronic fund transfer, but historical account data indicates that the customer has an upcoming large debit (e.g., a mortgage payment). Analysis of historical account data may trigger alerts to enterprise 104 associates, enterprise 104 administrators, and/or alter the requirements enterprise 104 has for a customer for a particular electronic fund transfer.

FIGS. 2 and 3 illustrate views 200 and 300 of an example interface of a system for collecting data and executing electronic transaction services. In the illustrated embodiment, views 200 and 300 represents an example interface 112 of associate portal 110. Employees of enterprise 104 and/or electronic transaction service customers of enterprise 104 may utilize the data fields in views 200 and 300 to input, edit, or view information related to electronic transaction services (e.g., electronic fund transfers).

View 200 includes customer information fields 202, account information fields 214, and electronic transaction service information fields 228. In certain embodiments, customer information fields 202 represent information related to an entity (e.g., an individual, business, organization, or other body) associated with an electronic transaction (e.g., electronic fund transfer). Customer information 202 fields may include customer name field 204, customer identification number field 206, customer address field 208, customer phone number field 210, and previous customer electronic transaction field 212 (e.g., previous electronic fund transfers).

Customer name field 204 receives and/or displays the name of the electronic transaction service customer initiating the electronic transaction service. Customer identification number field 206 receives and/or displays an identification number associated with the customer initiating the electronic transaction service. Customer address field 208 receives and/or displays an address associated with the customer initiating the electronic transaction service. Customer phone number field 210 receives and/or displays a phone number associated with the customer initiating the electronic transaction service. Previous customer electronic transaction field 212 is operable to receive and/or display electronic transactions associated with the customer initiating the electronic transaction service (e.g., previous electronic fund transfers). In certain embodiments, customers and/or enterprise employees (e.g., associates) can select a previously executed electronic transaction service to populate one or more data fields of views 200 and 300 with information associated with the previously executed electronic transaction service (e.g., customer information 202, account information 214, electronic transaction service information 228, recipient information 302, and/or intermediate bank information 342).

Account information fields 214 represent information related to financial accounts associated with an entity (e.g., an individual, business, organization, or other body) associated with an electronic transaction (e.g., wire and ACH transfer of funds). Account information fields 214 may include account field 216, account title field 218, other entity field 220, available balance field 222, ending balance field 224, and overdraft exception reason field 226. Account field 216 receives and/or displays a name, category, or identifier of a financial account associated with the electronic transaction service. In the illustrated embodiment, the electronic transaction service is electronic fund transfer and account field 216 depicts the name of the specific source account to be used in the electronic fund transfer. Account field 216 may include a category for cash as a source account. For example, a customer may not have an account with enterprise 104 and wants to use cash as the source of an electronic fund transfer. Account title field 218 receives and/or displays a secondary name, category, or identifier of a financial account associated with the electronic transaction service. In the illustrated embodiment, the electronic transaction service is an electronic fund transfer and account title field 216 depicts the type of financial account that is being used as the source account for the electronic fund transfer (e.g., checking, savings, etc.). Other entity field 220 receives and/or displays an indication of whether the electronic transaction service is being executed on behalf of another entity. In the illustrated embodiment of an electronic fund transfer, other entity field 220 depicts that the fund transfer is being executed on behalf of another entity and is operable to receive and/or display contact information for the other entity. Available balance field 222 receives and/or displays the current balance of the account identified in account field 216. In certain embodiments, system 100 is operable to access data related to the account identified in account field 216 to automatically populate available balance field 222 with current balance information. Ending balance field 224 receives and/or displays the future balance of the account identified in account field 216 after completing a proposed electronic transaction service (e.g., a wire and ACH transfer of funds). In certain embodiments, electronic transactions services may result in a negative balance in the account identified in account field 216. Enterprise 104 may execute an electronic transaction service (e.g., electronic fund transfer) despite the transaction service resulting in a negative balance. Overdraft exception reason field 226 receives and/or displays criteria that is satisfied by the specific electronic transaction service that justifies executing the electronic transaction service despite the resulting negative balance (e.g., enterprise 104 may extend an electronic transaction service customer a line of credit).

Electronic transaction service fields 228 represent information related to particular types of electronic transaction services. In the illustrated embodiment, the electronic transaction service is an electronic fund transfer from one account to another (e.g., wire or ACH transfer of funds), and the electronic transaction service fields 228 include fund transfer type field 230, country field 232, currency of recipient field 234, date field 236, fund transfer amount (USD) field 238, fund transfer amount (FX) field 240, exchange rate field 242, lock exchange rate field 244, waive fee field 246, fee amount field 248, reason waived field 250, and required identification field 252.

Fund transfer type field 230 receives and/or displays a category of electronic fund transfer (e.g., domestic or international). Country field 232 receives and/or displays an identifier of destination country of the electronic fund transfer (e.g., Canada). Currency of recipient field 234 receives and/or displays an identifier of the monetary currency used by the destination country (e.g., Canadian dollar (CAD)). Date field 236 receives and/or displays the date the electronic fund transfer will execute. Fund transfer amount (USD) field 238 receives and/or displays the amount of the electronic fund transfer in U.S. dollars. Fund transfer amount foreign exchange (FX) field 240 receives and/or displays the amount of the electronic fund transfer in the destination currency (e.g., Canadian dollars). Exchange rate field 242 receives and/or displays a current exchange rate between the source currency (e.g., U.S. dollars) and the destination currency (e.g., Canadian dollars). In certain embodiments, system 100 is operable to access current exchange rates and to automatically populate exchange rate field 242 and to calculate wire amount (FX) field 240. Lock exchange rate field 244 is operable lock a particular exchange rate (e.g., guarantee the exchange rate for a particular period of time), for example, once a customer accepts the exchange rate. Waive fee field 246 receives and/or displays an indication of whether fees associate with the electronic fund transfer are waived. Fee amount field 248 receives and/or displays a monetary amount of fees associated with the electronic fund transfer that are waived. Reason waived field 250 receives and/or displays criteria satisfied by the particular electronic fund transfer that justifies waiver of associated fees. Required identification field 252 receives and/or displays forms of identification (e.g., government ID, social security card, photo ID, etc.) a customer may need to present in order to execute a particular electronic fund transfer. In certain embodiments, the forms of identification need to be approved by an administrator.

View 300 includes recipient information fields 302 and intermediary bank information fields 342. Recipient information fields 302 include recipient name field 304, recipient account number field 306, recipient street address 1 field 308, recipient street address 2 field 310, recipient city field 312, recipient state field 314, recipient zip code field 316, recipient country field 318, recipient phone number field 320, purpose of payment field 322, search criteria field 324, bank ID field 326, bank street address 1 field 328, bank street address 2 field 330, bank city field 332, bank state field 334, bank zip code field 336, bank country field 338, and bank instruction field 340.

Recipient name field 304 receives and/or displays the name of the entity (e.g., person, business, or organization) receiving the electronic fund transfer. Recipient account number field 306 receives and/or displays the destination financial account number of the electronic fund transfer. Recipient street address 1 field 308, recipient street address 2 field 310, recipient city field 312, recipient state field 314, and recipient zip code field 316 receive and/or display address information associated with the entity identified in recipient name field 304. Recipient country field 318 receives and/or displays the destination country of the electronic fund transfer. Recipient phone number field 320 receives and/or displays a phone number associated with the entity identified in recipient name field 304. Purpose of payment field 322 receives and/or displays a category of electronic fund transfer (e.g., bill pay, personal, business, etc.). Search criteria field 324 receives and/or displays search criteria (e.g., name, city, street, etc.) used to identify a destination financial institution (e.g., bank) to receive the electronic fund transfer. Bank ID field 326 receives and/or displays an identification of a destination financial institution (e.g., bank) to receive the electronic fund transfer. Bank street address 1 field 328, bank street address 2 field 330, bank city field 332, bank state field 334, and bank zip code field 336 receive and/or display address information associated with the destination bank identified in bank ID field 326. Bank country field 338 receives and/or displays the country of the destination bank identified in bank ID field 326. Bank instruction field 340 receives and/or displays instructions for the bank identified in bank ID field 326 on handling the electronic fund transfer.

Intermediary bank information fields 342 include intermediary bank search criteria field 344, intermediary bank ID field 346, and cancel fund transfer field 348. Intermediary bank search criteria field 344 receives and/or displays search criteria (e.g., name, city, street, etc.) used to identify an intermediary financial institution (e.g., bank) to participate in the electronic fund transfer. Intermediary bank ID field 346 receives and/or displays the financial account number of an intermediary financial institution (e.g., bank) participating in electronic fund transfer. Cancel fund transfer field 348 is operable to cancel a proposed electronic fund transfer. In certain embodiments, electronic fund transfers may be canceled up to a pre-determined amount of time after initiating the electronic fund transfer (e.g., 30 minutes).

In certain embodiments, previous customer electronic transaction field 212 is operable to initiate a search for data populated in one or more of customer information fields (e.g., customer name field 204, customer identification number field 206, customer address field 208, and/or customer phone number field 210) in a database (e.g., database module 150) containing an archive of historical electronic transaction service data and return previously executed electronic transaction services associated with the data contained in one or more customer information 202 fields. A customer and/or enterprise employee (e.g., associate) may select a previously executed electronic transaction service and details associated with the selected previously executed electronic transaction service may automatically populate in one or more fields of views 200 and 300 (e.g., one or more customer information 202 fields, account information 214 fields, electronic transaction service information 228 fields, recipient information 302 fields, and/or intermediate bank information 342 fields).

Modifications, additions, or omissions may be made to views 200 and 300. Views 200 and 300 may include more, fewer, or other fields and may perform more, fewer, or other functionality. Any field of views 200 and 300 may be edited.

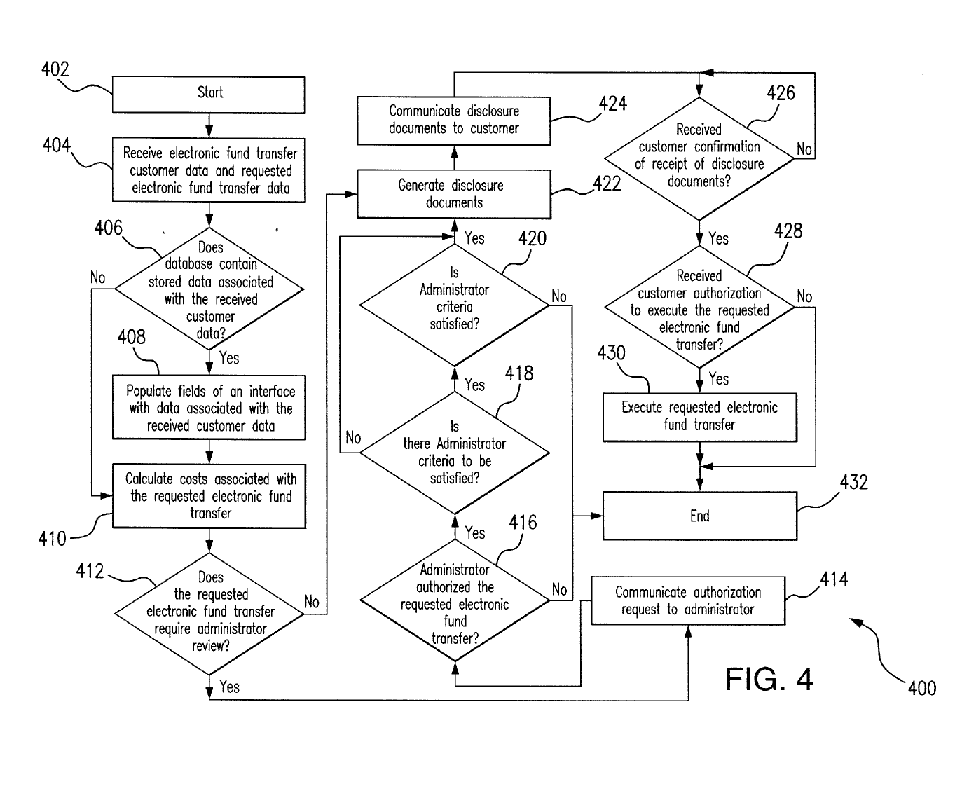

FIG. 4 illustrates a flow chart of an example method 400 for collecting data and executing electronic transaction services. In the illustrated embodiment, the electronic transaction service is an electronic fund transfer (e.g., electronic fund transfer). Method 400 begins at step 402. At step 404, data associated with a customer requesting an electronic fund transfer and data associated with an electronic fund transfer requested by the customer are received (e.g., at associated portal 110). At step 404, it is determined whether system 100 contains any stored data (e.g., in database module 150) associated with the received customer data. If system 100 contains stored data associated with the received customer data, the method continues to step 408 and data fields of an interface (e.g., interface 112 of associate portal 110) are populated with the stored data associated with the received customer data and the method continues to step 410. In certain embodiments, the populated data can be edited after it is populated into the fields. If system 100 does not contain stored data associated with the received customer data, the method continues to step 410.

At step 410, costs (e.g., taxes and fees) associated with the requested electronic fund transfer are calculated and the method continues to step 412. At step 412, it is determined whether the requested electronic fund transfer requires administrator approval (e.g., because of a resulting negative account balance, transfer amount exceeds allowed levels, or other reason). If the requested electronic fund transfer does not require administrator review, the method continues to step 422. If the requested electronic fund transfer requires administrator review, the method continues to step 414 and an authorization request for the requested electronic fund transfer is communicated to an administrator. At step 416, it is determined whether the administrator has authorized the electronic fund transfer (e.g., with an authorization response). If the administrator does not authorize the requested electronic fund transfer, the method ends at step 432. If the administrator authorizes the requested electronic fund transfer, it is determined whether there is administrator criteria (e.g., customer producing additional forms of identification, customer providing signatures, customer obtaining a line of credit, or other criteria) that must be satisfied before executing the requested electronic fund transfer. If there is not administrator criteria, the method continues to step 422. If there is administrator criteria, the method continues to step 420 and it is determined whether the administrator criteria is satisfied by the customer and/or the requested electronic fund transfer. If the administrator criteria is not satisfied, the method ends at step 432. If the administrator criteria is satisfied, the method continues to step 422.

At step 422, disclosure documents related to the requested electronic fund transfer are generated. At step 424 the generated disclosure documents are communicated to the customer. At step 426, it is determined whether the customer has confirmed receipt of the disclosure documents. If the customer has not confirmed receipt of the disclosure documents, the method returns to step 426 and continues to await confirmation from the customer. If the customer has confirmed receipt of the disclosure documents, the method continues to step 428 and it is determined whether the customer has authorized execution of the requested electronic fund transfer. If the customer does not authorize the execution of the requested electronic fund transfer, the method ends at step 432. If the customer does authorize the execution of the requested electronic fund transfer, the method continues to step 430 and the requested electronic fund transfer is executed. The method ends at step 432.

Modifications, additions, or omissions may be made to method 400. The method may include more, fewer, or other steps. Additionally, steps may be performed in any suitable order, in parallel, and/or sequentially. Any suitable component of may perform one or more steps of method 400.

Certain embodiments of the present disclosure may provide one or more technical advantages having specific technical effects.

In certain embodiments, a system for executing electronic fund transfers automatically populates data necessary to execute an electronic fund transfer from a database to an interface of a computing platform to reduce the amount of time a user must occupy the computing platform to execute the electronic fund transfer, thereby conserving the computational resources necessary to perform the electronic fund transfer that would be consumed by manually entering the necessary data.

In certain embodiments, a system for executing electronic fund transfers automatically generates documents with necessary fields completed, displays the generated documents, and/or receives customer confirmations (e.g., signatures) necessary to execute an electronic fund transfer to reduce the amount of time a user must occupy the computing platform to execute the electronic fund transfer, thereby conserving the computational resources necessary to perform the electronic fund transfer that would be consumed by manually completing the fields of the documents.

In certain embodiments, a system for executing electronic fund transfers electronically alerts administrators when an electronic fund transfer requires administrator review, electronically provides the administrator access to necessary data associated with the electronic fund transfer, and allows the administrator to electronically communicate authorization of the electronic fund transfer to reduce the time necessary to execute the electronic fund transfer, thereby conserving the computational resources necessary to perform the electronic fund transfer that would be consumed obtaining administrator review using less efficient contact methods.

Other technical advantages of the present disclosure will be readily apparent to one skilled in the art from the following figures, descriptions, and claims. Moreover, while specific advantages have been enumerated above, various embodiments may include all, some, or none of the enumerated advantages.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A system for executing electronic fund transfers, comprising:
a memory comprising a database, the database configured to store electronic fund transfer data;
a first interface communicatively coupled to the memory and configured to receive:
electronic fund transfer customer data associated with a customer; and
requested electronic fund transfer data describing an electronic fund transfer requested by the customer;
one or more processors communicatively coupled to the first interface and configured to:
identify, based on the received customer data, stored electronic fund transfer data associated with the received customer data;
populate fields of the first interface with the stored electronic fund transfer data associated with the received customer data;
determine, based on the received customer data, the stored electronic fund transfer data associated with the received customer data, and the requested electronic fund transfer data, that the electronic fund transfer requested by the customer requires administrator approval; and
generate an authorization request message that includes the requested electronic fund transfer data;
the first interface further configured to:
communicate the authorization request message to a second interface associated with an administrator;
receive an authorization response message from the administrator, wherein the authorization response message includes administrator criteria that needs to be satisfied by the customer to execute the requested electronic fund transfer; and
receive an indication that the customer has complied with the administrator criteria;
the one or more processors further configured to:
determine, based on the received customer data, the stored electronic fund transfer data associated with the received customer data, and the requested electronic fund transfer data, that the requested electronic fund transfer requires disclosure of one or more documents to the customer, confirmation from the customer that the customer received the one or more documents, and authorization from the customer to execute the requested electronic fund transfer; and
generate the required one or more documents based on the received customer data and the stored electronic fund transfer data associated with the received customer data;
the first interface further configured to:
indicate that the required one or more documents need to be disclosed to the customer, that the customer needs to confirm that the customer received the one or more required documents, and that the customer needs to authorize execution of the requested electronic fund transfer; and
receive an indication that the customer has received the one or more required documents, an indication that the customer received the one or more required documents, and an indication that the customer authorized execution of the requested electronic fund transfer; and
the one or more processors further configured to execute the requested electronic fund transfer after a predetermined amount of time, wherein the requested electronic fund transfer can be canceled during the predetermined amount of time.

2. A system for executing electronic fund transfers, comprising:
a memory comprising a database, the database configured to store electronic fund transfer data;
a first interface communicatively coupled to the memory and configured to receive:
electronic fund transfer customer data associated with a customer; and
requested electronic fund transfer data describing a requested electronic fund transfer requested by the customer;
one or more processors communicatively coupled to the first interface and configured to:
identify, based on the received customer data, stored electronic fund transfer data associated with the received customer data; and
populate fields of the first interface with the stored electronic fund transfer data associated with the received customer data.

3. The system of claim 2, wherein the requested electronic fund transfer data includes an amount of money in a first currency to be transferred and a destination for the electronic fund transfer;
the one or more processors further operable to:
determine that the destination for the electronic fund transfer uses a second currency; and
determine an exchange rate between the first currency and the second currency;
the first interface further configured to:
display the determined exchange rate;
indicate that the customer needs to accept the determined exchange rate; and
receive an indication that the customer accepts the determined exchange rate.

4. The system of claim 2, the one or more processors further configured to determine, based on the received requested electronic fund transfer data, costs associated with the requested electronic fund transfer, wherein the costs include taxes and fees.

5. The system of claim 2, the one or more processors further configured to:
determine, based on the received customer data, the stored electronic fund transfer data associated with the received customer data, and the requested electronic fund transfer data, that the requested electronic fund transfer requires disclosure of one or more documents to the customer, confirmation from the customer that the customer received the one or more documents, and authorization from the customer to execute the requested electronic fund transfer; and
generate the required one or more documents based on the received customer data and the stored electronic fund transfer data associated with the received customer data;
the first interface further configured to:
indicate that the required one or more documents need to be disclosed to the customer, that the customer needs to confirm that the customer received the one or more required documents, and that the customer needs to authorize execution of the requested electronic fund transfer; and
receive an indication that the customer has received the one or more required documents, an indication that the customer received the one or more required documents, and an indication that the customer authorized execution of the requested electronic fund transfer; and
the one or more processors further configured to execute the requested electronic fund transfer after a predetermined amount of time, wherein the requested electronic fund transfer can be canceled during the predetermined amount of time.

6. The system of claim 5, wherein the one or more required documents include one or more of:
a pre-payment disclosure document describing the costs associated with the requested electronic fund transfer, wherein the pre-payment disclosure document is generated before receiving authorization from the customer to execute the requested electronic fund transfer; and
an electronic fund transfer receipt describing the costs associated the requested electronic fund transfer, wherein the electronic fund transfer receipt is generated after receiving authorization from the customer to execute the requested electronic fund transfer.

7. The system of claim 2, the one or more processors further configured to:
determine, based on the received customer data, the stored electronic fund transfer data associated with the received customer data, and the requested electronic fund transfer data, that the electronic fund transfer requested by the customer requires administrator approval; and
generate an authorization request message that includes the requested electronic fund transfer data; and
the first interface further configured to:
communicate the authorization request message to a second interface associated with an administrator;
receive an authorization response message from the administrator, wherein the authorization response message includes administrator criteria that needs to be satisfied by the customer to execute the requested electronic fund transfer; and
receive an indication that the customer has complied with the administrator criteria.

8. The system of claim 7, the second interface communicatively coupled to the one or more processors and configured to:
receive the authorization request message from the first interface;
provide access to financial account data associated with the customer; and
receive one or more of authorization to execute the requested electronic fund transfer, denial of authorization to execute the requested electronic fund transfer, and authorization to execute the requested electronic fund transfer with the administrator criteria that needs to be satisfied by the customer to execute the requested electronic fund transfer;
the one or more processors further configured to generate the authorization response message; and
the second interface further configured to communicate the authorization response message to the first interface.

9. A non-transitory computer readable storage medium comprising logic for executing electronic fund transfers, the logic configured, when executed by a processor, to:
receive electronic fund transfer customer data associated with a customer;
receive requested electronic fund transfer data describing a requested electronic fund transfer requested by the customer;
identify, based on the received customer data, stored electronic fund transfer data associated with the received customer data; and
populate fields of a first interface with the stored electronic fund transfer data associated with the received customer data.

10. The non-transitory computer readable medium of claim 9, wherein the requested electronic fund transfer data includes an amount of money in a first currency to be transferred and a destination for the electronic fund transfer, the logic further configured to:
determine that the destination for the electronic fund transfer uses a second currency;
determine an exchange rate between the first currency and the second currency;
display the determined exchange rate on the first interface;
indicate at the first interface that the customer needs to accept the determined exchange rate; and
receive an indication that the customer accepts the determined exchange rate.

11. The non-transitory computer readable medium of claim 9, the logic further configured to determine, based on the received requested electronic fund transfer data, costs associated with the requested electronic fund transfer, wherein the costs include taxes and fees.

12. The non-transitory computer readable medium of claim 9, the logic further configured to:
determine, based on the received customer data, the stored electronic fund transfer data associated with the received customer data, and the requested electronic fund transfer data, that the requested electronic fund transfer requires disclosure of one or more documents to the customer, confirmation from the customer that the customer received the one or more documents, and authorization from the customer to execute the requested electronic fund transfer;
generate the required one or more documents based on the received customer data and the stored electronic fund transfer data associated with the received customer data;
indicate at the first interface that the required one or more documents need to be disclosed to the customer, that the customer needs to confirm that the customer received the one or more required documents, and that the customer needs to authorize execution of the requested electronic fund transfer;
receive an indication that the customer has received the one or more required documents, an indication that the customer received the one or more required documents, and an indication that the customer authorized execution of the requested electronic fund transfer; and
execute the requested electronic fund transfer after a predetermined amount of time, wherein the requested electronic fund transfer can be canceled during the predetermined amount of time.

13. The non-transitory computer readable medium of claim 12, wherein the required documents include one or more of:
a pre-payment disclosure document describing the costs associated with the requested electronic fund transfer, wherein the pre-payment disclosure document is generated before receiving authorization from the customer to execute the requested electronic fund transfer; and
an electronic fund transfer receipt describing the costs associated the requested electronic fund transfer, wherein the electronic fund transfer receipt is generated after receiving authorization from the customer to execute the requested electronic fund transfer.

14. The non-transitory computer readable medium of claim 9, the logic further configured to:
determine, based on the received customer data, the stored electronic fund transfer data associated with the received customer data, and the requested electronic fund transfer data, that the electronic fund transfer requested by the customer requires administrator approval;
generate an authorization request message that includes the requested electronic fund transfer data;
communicate the authorization request message to a second interface associated with an administrator;
receive an authorization response message from the administrator, wherein the authorization response message includes administrator criteria that needs to be satisfied by the customer to execute the requested electronic fund transfer; and
receive an indication that the customer has complied with the administrator criteria.

15. The non-transitory computer readable medium of claim 14, the logic further configured to:
receive at the second interface the authorization request message from the first interface;
provide access to financial account data associated with the customer at the second interface;
receive at the second interface one or more of authorization to execute the requested electronic fund transfer, denial of authorization to execute the requested electronic fund transfer, and authorization to execute the requested electronic fund transfer with the administrator criteria that needs to be satisfied by the customer to execute the requested electronic fund transfer;
generate the authorization response message; and
communicate the authorization response message from the second interface to the first interface.

16. A method for executing electronic fund transfers, comprising:
receiving electronic fund transfer customer data associated with a customer;
receiving requested electronic fund transfer data describing a requested electronic fund transfer requested by the customer;
identifying, by one or more processors, based on the received customer data, stored electronic fund transfer data associated with the received customer data; and
populating, by the one or more processors, fields of a first interface with the stored electronic fund transfer data associated with the received customer data.

17. The method of claim 16, wherein the requested electronic fund transfer data includes an amount of money in a first currency to be transferred and a destination for the electronic fund transfer, and the method further comprises:
determining, by the one or more processors, that the destination for the electronic fund transfer uses a second currency;
determining, by the one or more processors, an exchange rate between the first currency and the second currency;
displaying the determined exchange rate on the first interface;
indicating at the first interface that the customer needs to accept the determined exchange rate; and
receiving an indication that the customer accepts the determined exchange rate.

18. The method of claim 16, further comprising determining, by the one or more processors, based on the received requested electronic fund transfer data, costs associated with the requested electronic fund transfer, wherein the costs include taxes and fees.

19. The method of claim 16, further comprising:
determining, by the one or more processors, based on the received customer data, the stored electronic fund transfer data associated with the received customer data, and the requested electronic fund transfer data, that the requested electronic fund transfer requires disclosure of one or more documents to the customer, confirmation from the customer that the customer received the one or more documents, and authorization from the customer to execute the requested electronic fund transfer;
generating, by the one or more processors, the required one or more documents based on the received customer data and the stored electronic fund transfer data associated with the received customer data;
indicating at the first interface that the required one or more documents need to be disclosed to the customer, that the customer needs to confirm that the customer received the one or more required documents, and that the customer needs to authorize execution of the requested electronic fund transfer;
receiving an indication that the customer has received the one or more required documents, an indication that the customer received the one or more required documents, and an indication that the customer authorized execution of the requested electronic fund transfer; and
executing, by the one or more processors, the requested electronic fund transfer after a predetermined amount of time, wherein the requested electronic fund transfer can be canceled during the predetermined amount of time.

20. The method of claim 19, wherein the required documents include one or more of:
a pre-payment disclosure document describing the costs associated with the requested electronic fund transfer, wherein the pre-payment disclosure document is generated before receiving authorization from the customer to execute the requested electronic fund transfer; and
an electronic fund transfer receipt describing the costs associated the requested electronic fund transfer, wherein the electronic fund transfer receipt is generated after receiving authorization from the customer to execute the requested electronic fund transfer.

21. The method claim 16, further comprising:
determining, by the one or more processors, based on the received customer data, the stored electronic fund transfer data associated with the received customer data, and the requested electronic fund transfer data, that the electronic fund transfer requested by the customer requires administrator approval;
generating, by the one or more processors, an authorization request message that includes the requested electronic fund transfer data;
communicating the authorization request message to a second interface associated with an administrator;
receiving an authorization response message from the administrator, wherein the authorization response message includes administrator criteria that needs to be satisfied by the customer to execute the requested electronic fund transfer; and
receiving an indication that the customer has complied with the administrator criteria.

22. The method of claim 21, further comprising:
receiving at the second interface the authorization request message from the first interface;
providing access to financial account data associated with the customer at the second interface;
receiving at the second interface one or more of authorization to execute the requested electronic fund transfer, denial of authorization to execute the requested electronic fund transfer, and authorization to execute the requested electronic fund transfer with the administrator criteria that needs to be satisfied by the customer to execute the requested electronic fund transfer;
generating the authorization response message; and
communicating the authorization response message from the second interface to the first interface.
